(19) United States
(12) Patent Application Publication
(10) Pub. No.: US 2012/0237902 A1
(43) Pub. Date: Sep. 20, 2012

(54) Techniques for providing custom-formed implants

(75) Inventor: Joseph Maniscalco, Lexington, MA (US)

(73) Assignee: JOSEPH MANISCALCO DDS PC, Arlington, MA (US)

(21) Appl. No.: 13/423,194

(22) Filed: Mar. 17, 2012

Related U.S. Application Data
(60) Provisional application No. 61/453,791, filed on Mar. 17, 2011.

(51) Int. Cl. A61C 8/00

(52) U.S. Cl. 433/201.1

(57) ABSTRACT

Techniques for providing medical implants that have been custom-formed for a particular patient for surface treatment to alter properties of a surface of an implant component. A dental abutment implant component, custom-formed by removing or adding material or by providing an electronic or other specification for its fabrication, is provided to a third party for a surfaced treatment to be, performed. After the abutment with surface treatment is received from the third party, it may be moved to the patient's body. One preferred kind of surface treatment employs anodization of a dental metal material such as titanium to give a pink color for improved cosmetic results. Other kinds of surface treatment including bonding may also be used. A blank implant component that has a first portion compatible with a standardized implant component, and a second portion expressly intended to be custom-formed by removing material.

### CROSS-REFERENCE TO RELATED APPLICATIONS

The subject matter of this patent application is related to and claims priority from U.S. Provisional Patent Application Ser. No. 61/453,791, Maniscalco, Techniques for Dental Implants, filed 17 Mar. 2011, which is hereby incorporated by reference in its entirety.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

This invention generally relates to techniques for providing custom-formed medical implants for individual patients. More specifically, this invention relates to techniques for providing dental implant components such as abutments that are custom-formed for a particular patient and have a surface that is visible either directly or partially through the gums or through material of a prosthetic crown to achieve an improved cosmetic appearance of the custom-formed implant component.

### Description of Related Art

As illustrated in FIG. 1 and FIG. 2, a representative dental implant 110 has an implant body component 120 and an abutment component 130, along with a crown component 240 (shown in FIG. 2). The crown 240 fits over the abutment 130 and the entire implant fits in the patient's jaw to replace a natural tooth, as illustrated in FIG. 2. Further portions shown in FIG. 1 of the abutment 130 include the supra fixture portion 136 containing the chimney portion 136, and the shoulder portion 134 with the shelf portion 138 extending around the circumference of the chimney portion 136. Immediately below the supra fixture portion is the base portion 132. As shown, the representative chimney portion 136 may be tapered with the wider portion at the shoulder portion 134, and the shoulder portion 134 may be tapered to be less wide at the base portion 132. Further portions of the implant body component 120 include the collar portion 124 and the screw portion 122.

FIG. 2 shows the placement of the dental implant 110 when implanted, in side-by-side comparison with a natural tooth 200: the side-by-side views are the natural tooth view 250 and the dental implant view 260. Visible are the crown component 240, the gum line 222, the abutment 130, the implant body 120, as well as a natural tooth crown 228, gum tissue 226, bone 224, and the natural tooth root 220 and further portions already described. The shoulder portion 134 as shown is generally by preference underneath the gum tissue 226, but may be at least partially exposed to view or at least partially visible through the gum tissue 226 or through material of the crown component 240 at the margins.

Components of dental implants can be made of many different materials. Frequently titanium is used for the implant body component and other components, as titanium has properties that are advantageous in medical implants. Many other metal materials may also be used such as zirconium, gold, silver, vanadium, alloys of metals including exemplary alloys of zirconium alloyed with titanium or other materials, titanium alloyed with vanadium and/or aluminum, gold-platinum and silver-palladium alloys, base metallic alloys such as cobalt-chromium and nickel-chrome alloys, amalgams including silver and other amalgams, non-metallic materials such as various dental and other resins, composite materials, porcelain materials, ceramics that may be metallic and/or non-metallic, or combinations or configurations of materials.

Titanium is naturally gray in color. Where a surface of a dental implant such as one at least partly of titanium may be at least partially visible in vivo, this can result in an undesirable cosmetic appearance, as cosmetic appearance may be particularly determined by differences in color. For example, in dental implants gray titanium can cause a visible discoloration where it is covered by thin gum tissue (as illustrated at 310 in intra-oral view 300 of FIG. 3), exposed by inflamed gum tissue (as illustrated at 360 in intra-oral view 350 of FIG. 3), or where the surface of an abutment is near the surface of a crown (not illustrated, readily understood).

FIG. 3 at view 300 shows at area 310 where a visible discoloration (indicated by shaded portion 315) from the gray color of a titanium dental implant (readily understood) beneath the gum shows through thin gum tissue. The gap 325 shows where a crown component would be affixed to the implant abutment component of 310 between the adjacent natural central incisor tooth 320 and the natural lateral incisor tooth 330 in a particular patient's mouth.

FIG. 3 at view 350 represents an area of inflamed gum tissue 360, with visible discoloration 370 from an implant covered by thin gum tissue, and an exposed and visible portion 380 of the implant of 370 (beneath gum) due to gum recession at the base of the dental implant crown component 392 between the adjacent natural tooth with a conventional crown 394 and the natural lateral incisor tooth 396.

One current solution to this cosmetic issue is to use a standardized implant component, such as one available in a finite number of designs or sizes from a vendor. There are number of third-parties who process standardized dental implant components containing of titanium or other metal material by means of an anodization process to alter the color of an interior (and thus not visible in vivo) surface, for the purpose of color-coding to identify the size of the standardized component. Colors suitable for this purpose may include blue, yellow, green, and other colors. The Medcoat2000 process (see below) is one process that can be used to treat a surface of a dental implant component such as one containing titanium to produce a variety of colors.

Recently Keystone Dental Inc. has received regulatory approval for standardized titanium implant and abutment components in which portions of the surfaces of some of the components have been treated using an anodizing process to give the portions a pink color. Such components are being marketed by Keystone under the name of “Genesis: The Biomimetic Implant System” (www.keystonedental.com/products/genesis, fetched 6 Mar. 2012).

The implant components in FIG. 1 and FIG. 2 illustrate components like those of the Keystone kind. The Keystone components of 110 include the implant body component 120 and the abutment component 130 with the shoulder portion 134. The collar portion 124 of the body 120 is colored pink in components of the Keystone kind: the screw portion 122 of the implant body 120 is not colored pink, as the screw portion 122 is generally not visible in vivo. As further shown for the abutment component 130, in Keystone-kind components the entire surface of the standardized abutment component 130 is also treated by the Keystone anodizing process to be pink in color. The abutment 130 has a base portion 132, and a supra fixture portion 135 comprising the shoulder portion 134 extending to the shelf portion 138, continuing to the chimney (in some contexts also referred to as occlusal) portion 136.

Returning to FIG. 2, FIG. 2 shows a cross-sectional view of the corresponding portions of a representative natural tooth and a dental implant with crown. A natural tooth 200 on the left is shown with a natural crown 228, gum tissue 226, and bone 224. The implant components 110 are shown with the shoulder portion 134 of the abutment 130 (base portion is not visible) and the chimney portion 136. As shown, the gum tissue 226 ideally extends to the gum line 222 to cover edges of the artificial crown 240, but gum recession (not shown, see FIG. 3) may expose part of the abutment 130.

An anodization processes is one kind of surface treatment that may be employed on a medical or dental implant, and there are many variations that may be employed as matter of choice. Information on anodization and other surface treatments can be found on the Internet at en.wikipedia.org/wiki/anodizing (fetched Mar. 10, 2011) and bryanpryor.com/anodizing.php (fetched Mar. 10, 2011), as well as in further readily-available published references. As they are well readily understood by practitioners in the art, they need not be described in detail here. Likewise, the Keystone process is described in published materials from Keystone such as www.keystonedental.com/genesisimplant (fetched Mar. 13, 2011) and other published descriptions.

As a matter of reference, FIG. 4 reproduces information of a portion of a chart published by Keystone describing the overall Keystone process. The portion involving anodization is at 430 in column 3. Other aspects of surface treatment described by Keystone include sandblasting at 410 in column 1, and etching at 420 and 440 in columns 2 and 4, respectively.

Surface treatments such as those employing an anodization process can effect a desired change in surface properties, such as changing the color of the surface. For example, some anodization formulations may change surface color by including dye substances, or by reflective birefringence from the thickness of an anodization layer created in the surface of the material. There are a number of anodization processes and chemistries, and in the case of titanium there are processes to create one or more surface-treatment layers of titanium oxide or titanium nitride. Anodization may be employed for many metal materials in addition to titanium, such as tantalum and niobium which have a number of similar properties to titanium, aluminum, and for alloys. Anodization is one kind of many possible surface treatment ways of changing the surface properties of a material.

A pink color such as that used by Keystone has advantages in dental implants over the gray color of untreated titanium. One advantage is that the pink color is less visually apparent through the gums where the component comes near the surface of the gum, as well as being less visually apparent where it may be exposed at the gum-line boundary of the gum or the crown. Further, the pink color is less visually apparent where it may be visible through the material of the crown.

In a dental implant, a less apparent color has obvious cosmetic advantages. A pink color appearance is visually less apparent than the color of many dental materials, including many that may be applied in layers, such as the white color of titanium oxide or zirconia material, the yellow color of gold alloy material, as well as other materials. Thus in general, applied layers of such materials are disadvantageous for cosmetic reasons, but in some circumstances such as a request of a particular patient are preferred.

Applied layers of materials on a surface of a dental or other medical implant frequently have further disadvantages compared to other surface treatments such as anodization. For example, material from an applied layer may detach and invade the body of the patient. Further, applied layers in general may be prone to fracture, separation, poor durability, cracking, splitting, pitting, or other modes of failure.

Another disadvantage of many forms of an applied layer of material is that the applied layer may create an environment that increases the probability of bacterial growth, such as bacterial growth that can lead to dental caries or other infections.

One problem with the known solution of implanting standardized implant components with a surface treatment is that in many instances it is desirable or even necessary to custom-form at least a portion of an implant for a particular patient, and for a particular anatomical setting. As the implants are pre-treated, upon customizing the implant, the dental practitioner may need to remove part of the coloring, and the cosmetic benefit of the pre-treatment is lost.

Preparation of a dental implant is often divided between a dental practitioner and a denial technician. The dental technician may work in a dental laboratory removed from the dental practitioner's practice. Further, the crown component of a dental implant is often custom-formed, and the abutment component may be custom-formed also. Custom-formed implant components are also referred to as custom implant components.

In current practice, a dental practitioner performs surgical procedures to implant an implant body component in a patient, and then makes a dental impression of the implant site with the implant body and adjacent anatomy. The dental impression is then sent to a dental technician at a dental laboratory. The dental technician both selects a standardized, or stock, abutment component to fit the impression and custom-forms a model of a crown to fit the impression (and thus to fit the patient). Prior to making the crown model, the dental technician may also remove material mechanically from the abutment such as with a dental drill from the shelf portion of the abutment as a limited form of custom-forming the abutment. This may be done to try to bring the edges of the crown where it would fit on the abutment below the patient's gum line or for another reason. The technician then creates a crown from the crown model and returns the crown model and standardized abutment (potentially with limited custom-forming to the shelf surface) to the dental practitioner to be implanted. Alternatively, the dental technician may, without custom-forming the shelf portion, use an analog replica of a selected standardized abutment with a number of identical dimensions to a standardized abutment the dental practitioner will use. The dental practitioner may make final custom-forming changes to the crown.

A dental practitioner and dental technician may also follow a similar set of actions to the above, but the technician may custom-form the abutment in a more extensive fashion by removing material from the sides of the shoulder portion to change the profile and cross section of the shoulder portion to achieve a better cosmetic appearance, to better fit the anatomy of the patient's mouth, or for other reasons.

Alternatively, a dental practitioner performs surgical procedures to implant an implant body component in a patient, installs a standardized abutment on the implant body, and then makes a dental impression of the implant site with the implant body, the abutment and adjacent anatomy. Prior to making the impression, the practitioner may custom-form the abutment in the manners just described. The dental impression is then sent to a dental technician at a dental laboratory either with the actual abutment or with an analog replica of the abutment with a number of identical dimensions—the latter requires that the practitioner not have custom-formed the abutment. The dental technician custom-forms a model of a crown to fit the impression. The technician then creates a crown from the crown model and returns the crown model and the practitioner's abutment to the dental practitioner to be implanted. If the practitioner did not custom-form the abutment and instead sent an analog abutment to the technician, it may not be necessary to return the analog to the practitioner.

Methods used to create the crown from the crown model include molding and casting, and also laser-scanning or conoscopic scanning of the crown model and subsequently milling a crown according to digital data obtained by the scanning. Conoscopic scanning can also be used to scan the dental impression itself, and a crown milled from this data. In the exemplary case of scanning of the dental impression, it may not be necessary to create a physical crown model.

With respect to custom-forming an abutment, there are limitations of standardized components such as those of Keystone. As is readily apparent, it is not possible to custom-form by removing material from the surface of an implant component such as from a shoulder portion of a dental abutment without removing a part of the surface of the component. If a portion of any surface removed has been treated, removal exposes underlying material. In a case such as a Keystone abutment, this would remove the pink color and expose the titanium material in a portion of the surface, thus losing the cosmetic color or other benefits of the surface treatment. This can be particularly problematic, as it is very possible that a dental practitioner may want to custom-form a portion such as the shoulder portion of the abutment by removing material from one or more sides or surface portions.

Thus there is a need for techniques to provide custom-formed medical implants that include the cosmetic benefits of standardized implants pre-treated with a surface treatment.

### BRIEF SUMMARY OF THE INVENTION

The present invention is directed to medical implant components in general, and in particular to dental implant components such as dental abutments that are custom-formed for use in a particular patent, following which a surface treatment is performed on the component. In another aspect, a medical implant component such as a dental implant abutment has a first portion that is compatible with a corresponding portion of a standardized implant component, and a second portion intended to be custom formed.

In one aspect, an object of the invention is achieved by a method of making a custom-formed medical implant. A portion of an implant component that has been custom-formed for a particular patient by a first medical practitioner is received, a surface treatment is performed on a portion of its surface, and the component portion is then provided to a second medical practitioner for implantation in the particular patient. The first and second practitioners may be the same practitioner, and the implant component may be a component of a dental prosthesis. The component may have been custom-formed by removal of material from its surface, and may be custom-formed according to a specification.

In further aspects, the implant portion may be comprised of a metal material suitable for use in a human body, and the surface treatment may comprise anodizing a portion of its surface, or may comprise bonding a material to its surface.

In another aspect, an object of the invention is achieved by a method in which a portion of a medical implant is custom-formed for a particular patient, the custom-formed portion is provided to another entity for a surface-treatment to be performed, and receiving the implant portion after it has been treated; the implant portion may then be affixed to the body of the particular patient. The implant portion may be a portion of a dental prosthesis. The implant portion may be custom-formed by creating a specification for the form of the implant portion, and the component may be provided by providing the specification to the entity. The implant component may also be custom-formed by removing material.

In an additional aspect, an object of the invention is achieved by a custom medical implant, produced by a process of custom-forming a portion of a medical implant for use in a particular patient, and performing a surface treatment on a surface of the implant after it has been custom formed. The medical implant may be a dental implant, the surface treatment may include anodizing a portion of the surface, and the portion of the implant may be fabricated according to a specification.

In another aspect, an object of the invention is achieved by a medical implant component that has a first portion that is compatible with a corresponding portion of a standardized component, and a second portion that is different from its corresponding portion in the standardized component: the second portion is intended to be custom formed for use in a particular patient's body. The implant component may be a dental implant component, such as a dental abutment implant component; the portion intended to be custom-formed may be custom-formed in part by removing material.

In yet a further aspect of the present invention, an object of the invention is achieved by method of providing a custom dental implant abutment comprised at least in part of a titanium material, and material is removed from a portion of a surface of the abutment to custom-form the abutment for a particular patient. The abutment is provided to another entity for a surface treatment including anodization of a part of the surface to produce a pink color, and after the surface treatment has been performed, received and affixed to the patient's mouth by attachment with an endosseous dental implant component implanted in the patient's mouth.

Upon perusal of the Detailed Description and drawings below, other objects and advantages will be apparent to those skilled in the arts to which the invention pertains.

### BRIEF DESCRIPTION OF THE SEVERAL VIEWS OF THE DRAWINGS

FIG. 1 is a view of a representative dental implant of the Keystone kind, showing an implant body component and a corresponding implant abutment component.

FIG. 2 shows side-by-side cross-sectional views of a dental implant of the Keystone kind and of a natural tooth.

FIG. 3 shows two different intra-oral views of an implant abutment component in a patient's mouth in which the color of the abutment component is visible in the patient's mouth.

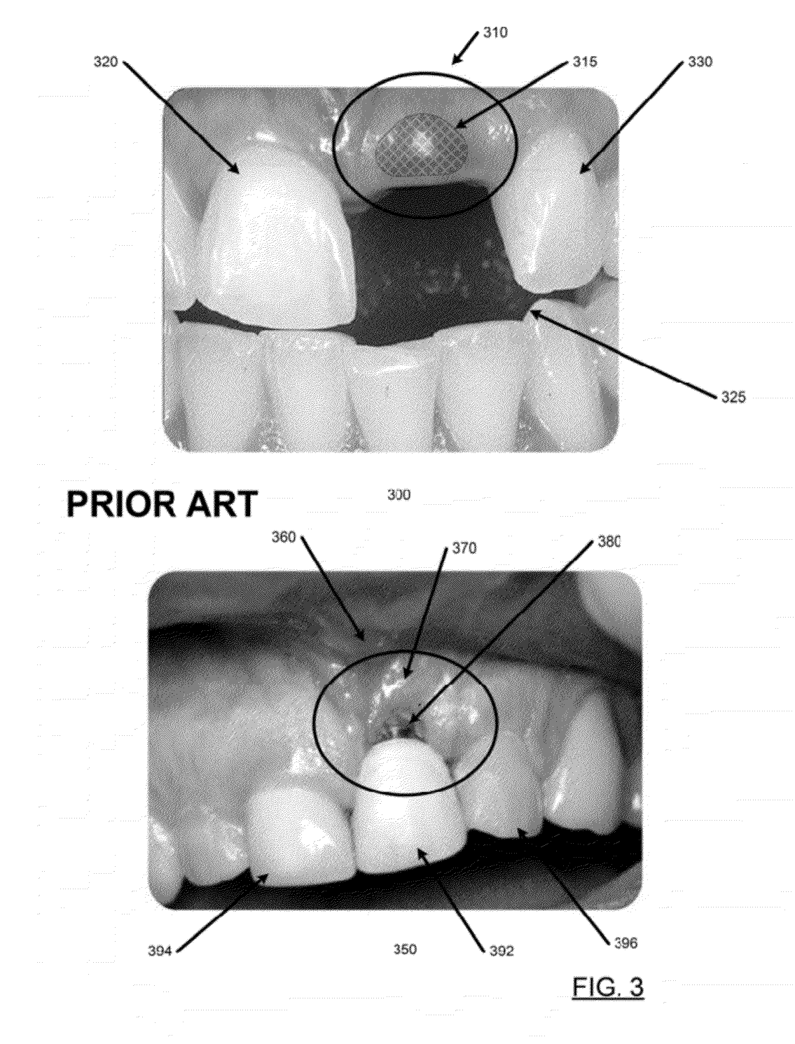

FIG. 4 shows information from material published by Keystone concerning a Keystone surface-treatment process.

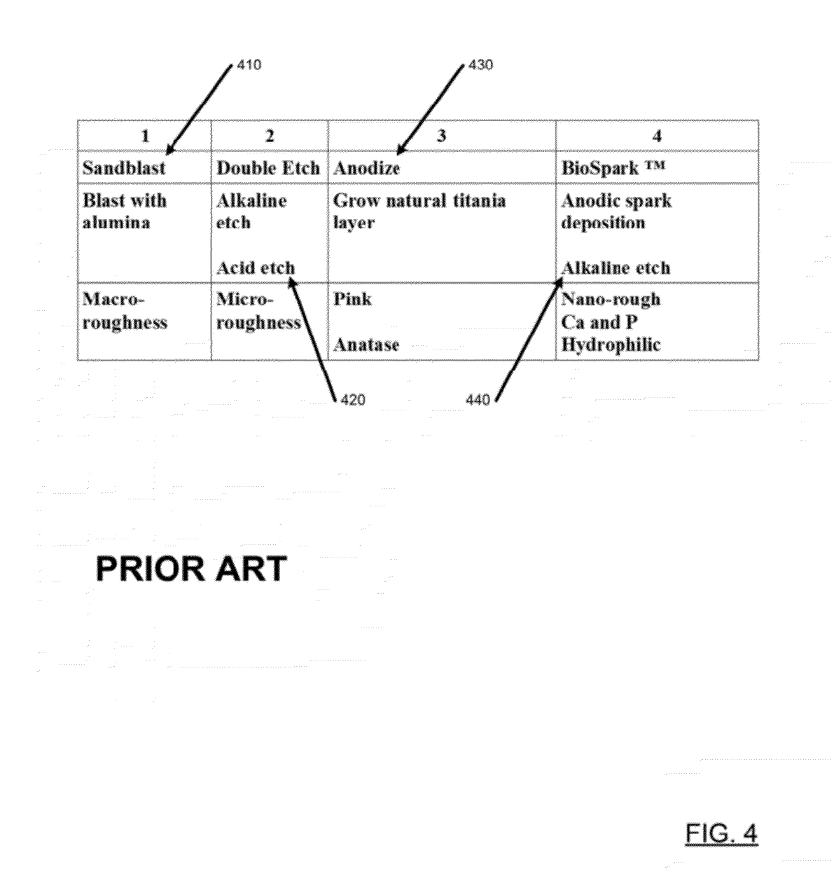

FIG. 5 shows a view illustrating the form of a representative standardized dental abutment component and a view illustrating the form of a custom-formed dental abutment component.

FIG. 6 shows, in flowchart form, steps included in an embodiment of the invention.

FIG. 7 shows views illustrating two embodiments of blank implant abutment components.

FIG. 8 shows, in flowchart form, steps included in a further embodiment of the invention.

FIG. 9 shows, in flowchart form, steps included in an additional embodiment of the invention.

FIG. 10 shows, in flowchart form, steps included in a further additional embodiment of the invention.

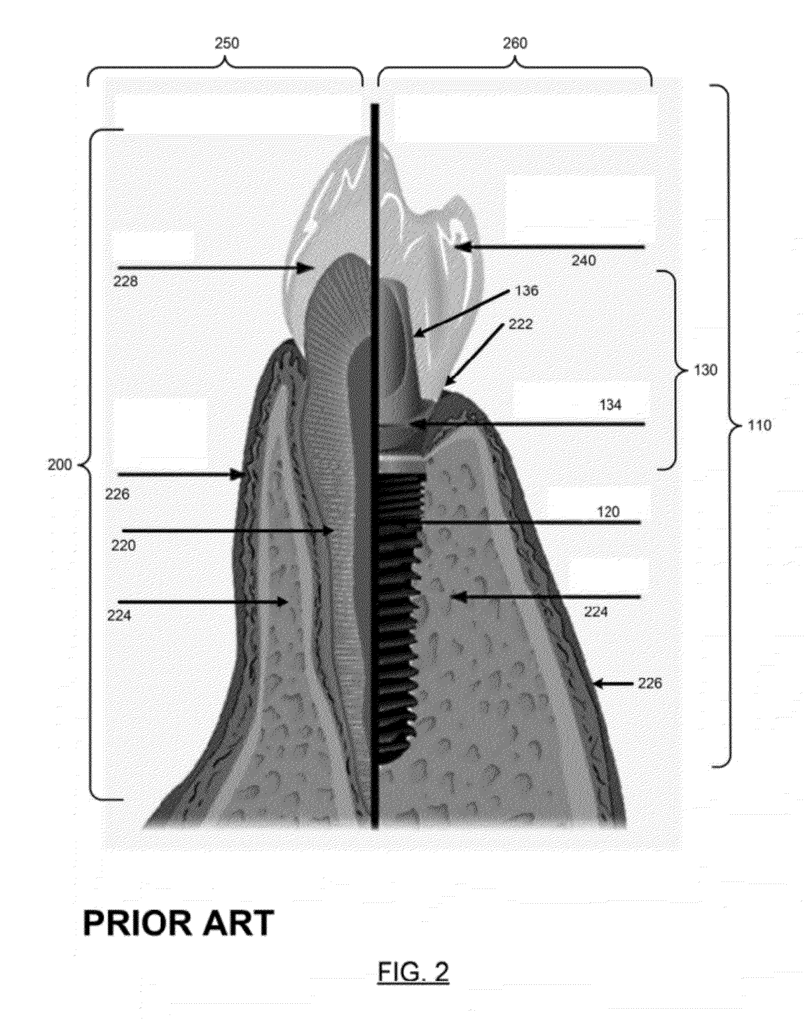

Reference numbers in the drawing have three or more digits: the two right-hand digits are reference numbers in the drawing indicated by the remaining digits. Thus, an item with the reference number 203 generally first appears as item 203 in FIG. 2.

### DETAILED DESCRIPTION OF THE INVENTION

The following Detailed Description of the invention discloses embodiments of techniques for providing a medical implant, such as a dental implant, that is custom-formed for a particular patent and includes a surface treatment that is applied after customization. After the surface treatment has been performed, the implant can be implanted in the patients body.

### Techniques

In the following disclosures, references to dental implants are exemplary for other medical implants including titanium or other implants that may be employed in surgery such as restorative surgery for the ear or nose or other parts of the body, including implants covered at least in part by a silicone or other material for cosmetic or other purposes: references to titanium are understood to be exemplary and to include other materials that may be used in medical or dental implants now or in the future. Details readily understood are omitted for clarity and brevity.

It is a purpose of the present invention to provide techniques for overcoming limitations of the present art regarding custom-formed dental implants and surface-treatment of dental implant components.

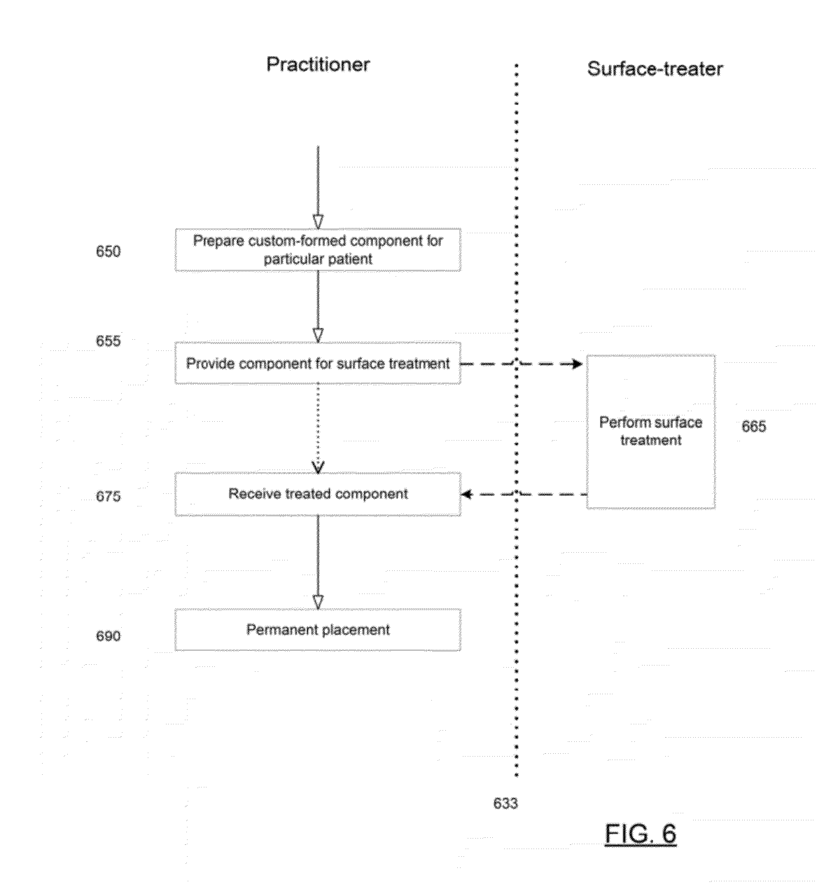

In partial overview, an embodiment for the invention includes the steps of FIG. 6. FIG. 6 illustrates steps performed by two entities: a dental or medical practitioner (henceforth dental practitioner or practitioner) who custom-forms an implant component, and an entity that performs the surface treatment (henceforth surface-treater). Steps performed by the practitioner are to the left of the dotted line 633, and steps performed by the surface-treater are to the right of the dotted line 633.

Initially at the step 650, the practitioner prepares a custom-formed implant component for a particular patent, such as by milling or abrading an implant component to have the desired shape for the particular patent.

Next, as shown at step 655, the practitioner provides the custom-formed implant component to a surface-treater, as indicated by the dashed line from the step 655 to the step 665, for the purpose of a surface treatment being performed on at least a portion of a surface of the component. The dotted line from step 655 to the step 675 illustrates that the practitioner then waits to receive the component with surface treatment from the surface-treater.

The surface-treater, having received the custom-formed implant component from the practitioner, performs a surface treatment on a least a portion of the components surface as shown by the step 665, and returns the treated component to the practitioner, as indicated by the dashed line from step 665 to the practitioner's step 675.

At the step 675, the practitioner receives the custom-formed implant component with surface treatment from the surface-treater, and next, as shown at the step 690, moves the implant component to patient's body and affixes or implants it permanently in the patient's mouth.

There are many known techniques for custom-forming an implant to fit a particular patient. Any of these may be used by various embodiments of the invention. Further, the kinds of medical or dental implants for which the techniques may be used is not limited to particular kinds medical or dental implants. Medical and dynamic science are dynamic fields, and the techniques may be used with future kinds of implants, materials, and surface treatments as well.

In the present context, dental implants include one or more supportive structures placed in the mouth to anchor or to support one or more crowns, bridges, dentures or other dental prostheses, various forms of dental restorations, orthodontia, or for another purpose, whether placed temporarily or permanently. In context, an implant is readily understood to refer to an implant component such as an endosseous implant or a body component or an abutment of a dental prosthesis, an implant of a single piece, or collectively to a medical or dental prostheses or portion thereof made up of one or more components of which at least one component is implanted in a patient's body.

### Custom-Forming

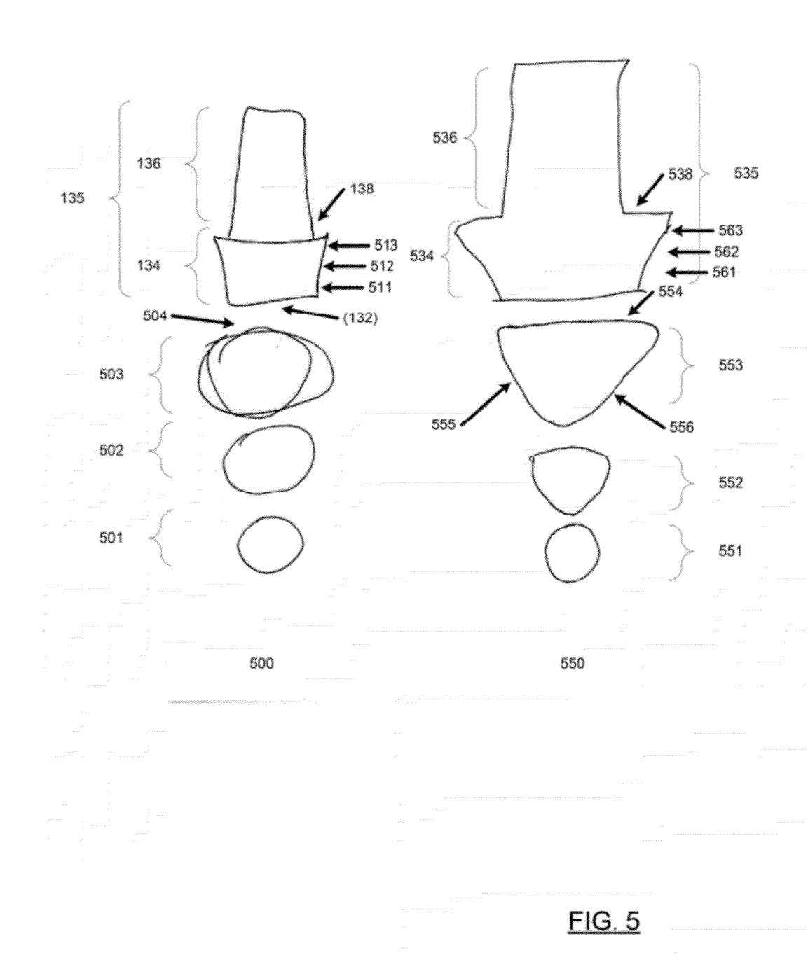

In some embodiments, a standardized abutment is custom-formed by removing material. FIG. 5 illustrates representative differences in form between a exemplary standardized abutment component that is not custom-formed for a particular patient, and the abutment as it would be custom-formed according to step 650 of FIG. 6. In some embodiments, a dental practitioner or technician custom-forms a standardized abutment component by removing material from the standardized abutment with a high-speed dental drill with a diamond bur: it other embodiments, material is removed with a dental milling machine. FIG. 5 is approximate and illustrative, and a number of dimensions are shown not to scale for clarity.

In FIG. 5, the view 500 illustrates the form of a representative standardized abutment by showing supra fixture portion 135, with the chimney portion 136 and the shoulder portion 134. Also shown is the shelf portion 138 on the shoulder portion 134.

View 550 illustrates the form of an abutment by showing supra fixture portion 535 as it may be custom-formed for step 650 of FIG. 6, with the chimney portion 536 and the shoulder portion 534. Also shown is the shelf portion 538 on the shoulder portion 534.

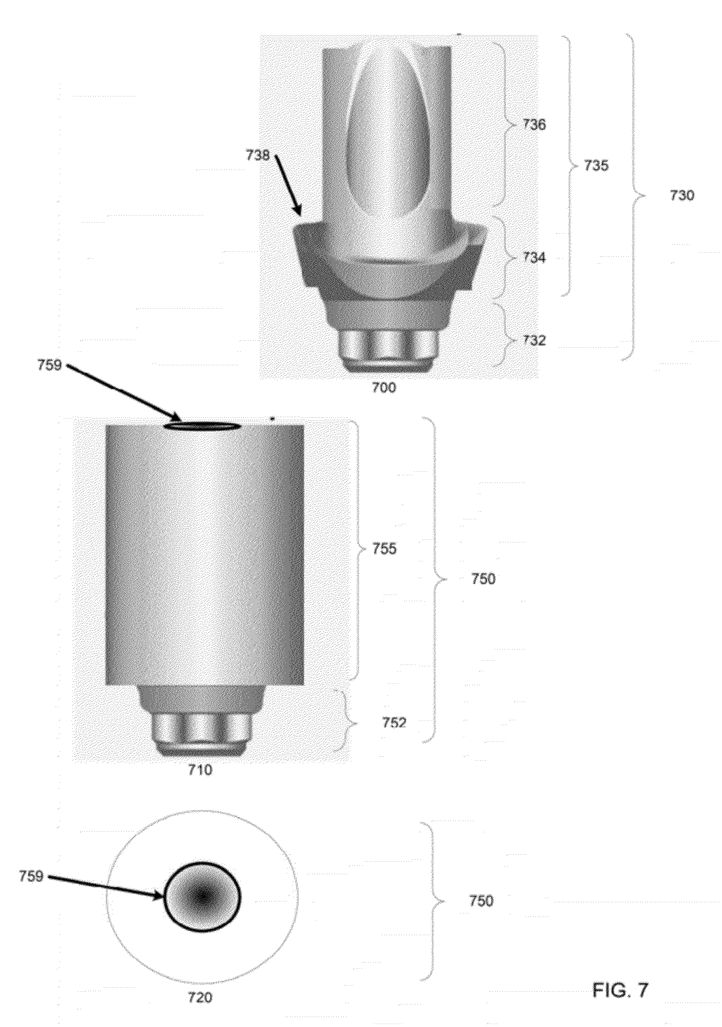

In some embodiments, the custom-formed abutment of supra fixture portion 535 may be custom-formed from a blank abutment (see example of FIG. 7 below) similar to the standardized abutment of the supra fixture portion 135, but with some dimensions altered to facilitate the removal of material from the blank abutment using dental tools or by milling. In one exemplary form, prior to custom forming shoulder portion 534 and shelf portion 538 of the custom-formed abutment supra fixture portion 535 may be wider than corresponding shoulder portion 134 and shelf portion 138 of the representative standardized abutment supra fixture portion 135.

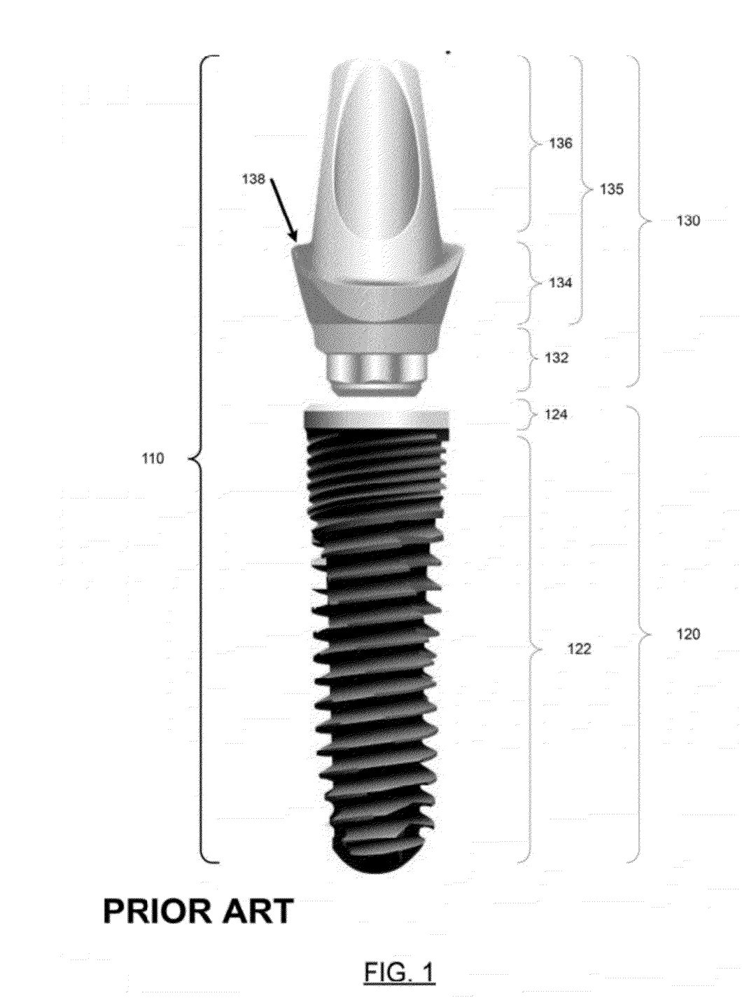

The arrows 513, 512, and 511 illustrate the locations of three corresponding cross-sectional views 503, 502, and 501 showing the cross-sectional form of the shoulder portion 134 of the standardized abutment of 135. The cross-sectional view location 513 is near the shelf portion 138, the cross-sectional view location 511 is near the base portion 132 (not shown, see FIG. 1 and FIG. 2), and the cross-sectional view location 512 is located between the locations 513 and 511.

The locations in the custom-formed abutment supra fixture portion 535 for the cross-sectional views 553, 552, and 551 are analogous to those of the cross-sectional views 503, 502, and 501 respectively for the standardized abutment supra fixture portion 135, as are the view locations 563, 562 and 561 to the view locations 513, 512, and 511.

The side 504 of the cross-sectional view 503 is the side of standardized abutment of 130 facing the tooth front side in vivo in the patient's mouth. Similarly the arrow 554 indicates the tooth front side for the custom-formed abutment of 535 in the cross-sectional view 553.

As indicated by the cross-sectional view 503, 502, and 501, the shoulder portion 134 of the representative standardized abutment supra fixture portion 135 has an approximately round form along a taper from the shelf portion 138 to the base portion 132 (shown in FIG. 1). Other standardized abutments may have other standardized forms.

Regarding the shoulder portion 534 of the custom-formed abutment of 535, in some embodiments the dental practitioner, or alternatively a third party such as a dental laboratory technician or one or more parties according to a specification or model of the practitioner, custom-forms the shoulder portion 534 of the custom-formed abutment to have a more triangular form near the shelf portion 538 and gradually transitioning to a round form near the base portion of the abutment (base portion not shown, see FIG. 1). The cross-sectional view 553 has a flatter side 554 facing the tooth front side than corresponding side 504 of the cross-sectional view 503 of the standardized abutment supra fixture portion 135. Similarly, the other two sides 555 and 556 are custom-formed for a more triangular form as indicated. As shown in the corresponding cross-sectional views 552 and 502, and 551 and 501, the triangular form of at the cross-sectional location 563 gradually tapers through the cross-sectional location 562 to the round form of the cross-sectional location 561.

A function of the triangular or other custom-formed form is to achieve a better cosmetic appearance. Another possible function of a custom-formed form is to provide better anatomical fit with teeth or or other implants adjacent to the dental implant in vivo with the anatomy of the particular patient, and it can be custom-formed to be generally more similar to the form and dimensions of a portion of the particular natural tooth the implant replaces. Although similar teeth such as bicuspids in general have a similar form among patients, the dimensions and details of anatomical form may vary substantially from one patient to another.

The triangular form is exemplary, as in a particular instance the custom-formed form desired may be any regular or irregular form or cross-section as a matter of choice, such as for the anatomy of the particular patient and circumstances of the implant.

Further, there are multiple methods and variations of methods for forming a material such as titanium that may be employed to produce a custom form for a dental implant component. For example, one variation is to take a standardized or blank dental implant abutment containing titanium, and using a dental hand-piece with a diamond or carbide dental bur, custom form the standardized or blank titanium abutment to the desired form. An example of a blank implant component is one specifically intended to be custom-formed. As titanium and many other materials of dental implants may be formed by milling, another variation is to use a dental laboratory milling unit to mill a prefabricated or blank dental implant abutment.

A further variation is to make a dental model of a particular patient's mouth. In the dental model, a plastic base is inserted into a dental implant analog made with a material such as a plastic, and dental wax is applied to the analog to achieve the desired form. In the present context, a dental implant analog is at least a partial copy of an implant component intended for trial use such as fitting an implant modeling a patient, and often made out of different material than the actual implant component, for example stainless steel and/or plastic instead of titanium.

The dental model with the analog and additional wax in the desired form of the dental implant abutment is placed by the practitioner into a 3-axis dental model scanner (henceforth DWOS for brevity) which scans the form and produces scan data in computer-readable form representing the form. Dental model scanners are readily understood, as are software programs for dental practitioners to create specifications of forms, such as those described by Dental Wings (Dental Wings Open Software, www.dental-wings.com, fetched 10 Mar. 2012)

The specification or scanned data are sent to a third-party dental milling center where a custom dental implant abutment of the desired form is milled from a titanium block or blank component, and the custom-formed component is then returned to the practitioner. There are a number of dental milling centers that provide third-party services, such as those that are marketed as part of the Atlantis offerings by Astratech Dental (www.astratechdental.com, fetched 10 Mar. 2012).

A further variation is to insert into a dental model a model abutment containing plastic material or metal material such as gold and plastic material, and apply dental wax to the model abutment to form the desired form: one example of such model abutments are the castable abutments referred to in the art as UCLA abutments or University of California at Los Angeles abutments, in which a plastic burnout pattern is waxed and then an abutment is cast by a lost-wax technique. Next, the dental model with model abutment is provided to a third-party dental milling center such as that of the previous example as a specification: the third party performs the scanning step prior to milling the custom dental implant abutment of the desired form, and then returns the custom-formed component to the practitioner.

In another variation, the specification of the desired form is prepared by a first practitioner and provided to a third party for fabricating the custom-formed component, and the third party returns the custom-formed component to a second practitioner. The second practitioner may then implant the component in the patient's mouth.

A further variation is taking the dental model of the patients mouth that has the copy of the dental implant in it. A special scanning post is inserted into the dental implant analog and the model is placed in the dental model scanner (DWOS: see above), which scans the form and produces scan data in computer-readable form representing the form. Using appropriate computer software (DWOS software with implant module: see above) that is provided by the vendor with the scanner, a practitioner produces a form specification in computer-data form for the entire custom dental implant abutment in the form of the analog with additional dental wax. The specification is then sent to a third-party dental milling center (see above) where a custom dental implant abutment of the desired form is milled from a titanium block or blank component, and the custom-formed component is then returned to the practitioner. In the alternative, the the practitioner may provide the scan data itself to the dental milling center as the specification: the milling center may produce a final form specification for an appropriate final custom-formed form as part of creating the custom-formed component.

After the custom-formed component is produced, the dental practitioner may move the component to the patient's mouth to check the form of the component in situ, and may at that time further custom-form or adjust the form of the component either by removing material from or adding material to the component, or by producing a revised specification or model for the form for a new and modified custom-formed component.

### Blank Component

FIG. 7 shows views of two embodiments of a blank component in the form of a blank abutment component compatible with components used with the standardized abutment component of FIG. 1 and FIG. 2.

The first embodiment of a blank dental implant abutment 730 is shown in side view 700. The base portion 732 of the blank abutment component 730 has similar dimensions to the base portion 132 of the standardized abutment of FIG. 1 and FIG. 2, and thus may be used compatibly with the standardized body component 120 of FIG. 1. In some embodiments, at least a portion of the base portion 732 has identical dimensions to base portion 132 of FIG. 1.

Other dimensions of the blank abutment component 730 are different from those of the standardized abutment component of FIG. 1, for example the chimney portion 736 may have greater diameter as shown, to facilitate the removal of material to custom-form the blank component to a desired form, such as a form that may be greater or lesser in different dimensions than the standardized component, or in portions have an entirely different form.

As can be seen from FIG. 1 and view 700, the shelf portion 738 of the blank component 730 is wider than the corresponding shelf portion 138 of the standardized component, and the shoulder portion 734 of the blank component protrudes in portions to be greater than the corresponding portions of the standardized component of FIG. 1. Further, the chimney portion 736 of the blank component 730 is less tapered than the chimney portion 136 of the standardized component. In some embodiments, a practitioner may, by removing material, custom-form the chimney portion 736 to have a different taper or a more complex or more simple form than the tapered form of the chimney portion 136 of the standardized component.

A second embodiment 750 is shown in side view 710 and top view 720. The base portion 752 of embodiment 750 as shown in side view 710 has been pre-milled to be compatible with the base portion 132 of the standardized abutment of FIG. 1 and FIG. 2.

The supra fixture portion 755 of blank abutment component embodiment 750 may be cylindrical as shown, and not have been pre-formed to have a shelf portion or other standardized portions like that of the standardized abutment of FIG. 1. The supra fixture portion 755 is largely featureless, on its exterior intended to be custom-formed. In the center of the top surface of the supra fixture portion 755, a threaded cylindrical screw hole 759 is visible to accept an attachment screw (not shown) compatibly to a similarly threaded hole as may be in the abutment component of FIG. 1 for attachment of either abutment to the base component 120.

The top view 720 shows the top of supra fixture portion 755 of the blank abutment 750. As shown, the screw hole 759 is centered in the top surface of supra fixture portion 755. The supra fixture portion may be custom-formed by the removal of material to a custom-formed form for use in a particular patient. In some embodiments, the screw hole 759 is not present, or is not threaded, or may have a form other than cylindrical, and may or may not be compatible with a particular standardized implant component.

In other embodiments, other dimensions may be different from a standardized implant component with which the blank implant component is compatible, or some portions may be differently formed, and other dimensions or portions may be compatible with a number of standardized implant components. The portion that may be custom-formed may be wholly or in part cylindrical or approximately cylindrical, or at least approximately triangular,and may have a flat or rounded top, or another form. The portion that is compatible with a corresponding portion in a standardized implant component may be compatible with a particular standardized implant component, such as one provided by a particular vendor, or with a number of standardized implant components. Blank implant components may be made for other forms and kinds of implant components, and are not limited to dental implant components.

Surface Treatment

Once the custom-formed component has been custom-formed, the practitioner then provides the implant component to a third party for a surface treatment to be performed. In one representative embodiment, the surface treatment includes an anodizing process suitable for medical or dental implants such as one similar to the Medcoat2000 process (medcoat2000.com, fetched 10 Mar. 2012), which may be performed on a quantity of components, or individually to a single component, to produce a pink color or other color on the entire surface of the implant. Alternatively, the surface treatment may be performed for a portion of a surface of the implant. While a surface treatment to produce a pink color is one preferred form, other colors or kinds of surface treatment may also be employed depending on the design choice of the practitioner or other considerations, such as a cosmetic preference of the patient or other properties.

### Implanting or Affixing

After the surface treatment is performed, the component is returned to the practitioner for use in the patient's mouth. Alternatively, the component may be returned to a second or third practitioner to be moved to the patient's mouth and implanted.

### Kinds of Surface Treatments

There are many ways to perform a surface treatment in keeping with the techniques: forms of anodization as referenced herein are exemplary. For example, one kind of surface treatment is the Keystone anodization treatment or a variation thereof. Another method for surface treatment is to attach the abutment component at the chimney portion (136 in FIG. 1) to a holder and to surface-treat portions of the abutment component by immersion in an anodizing solution as part of an anodizing treatment: such general methods as they may be applied are readily understood. In other embodiments, the abutment component is attached to an analog replica of an implant body component, and by means of the analog immerse the entire abutment component in an surface-treatment solution. After the surface treatment is complete, the abutment can be removed to be returned to a practitioner, or treated further.

In yet other embodiments, the entire surface or multiple surface portions may be treated, different surface treatments perform ed on different surface portions, or a portion of a treated surface may be removed after treatment. Other kinds of surface treatment that may be employed include chemical or ionic etching, electronic etching, surface irradiation, thermal treatment of the surface by heat and/or cold, treatments that involve cycling or multiple steps of treatment, bombarding the surface with atoms, molecules or particles of one or more substances, treatments employing fields such as electrical or electromagnetic fields, treatments that alter the microscopic structure and/or composition of the material at or near the surface, and so forth.

Since the techniques of the invention may be used with any appropriate form or kind of surface treatment or custom-forming for a particular medical implant, another way of treating the surface is to provide the custom-formed component to a third party who may use any appropriate technique including techniques that are in part proprietary to treat the surface of the component, or receiving the component after a surface treatment or custom-forming has been performed.

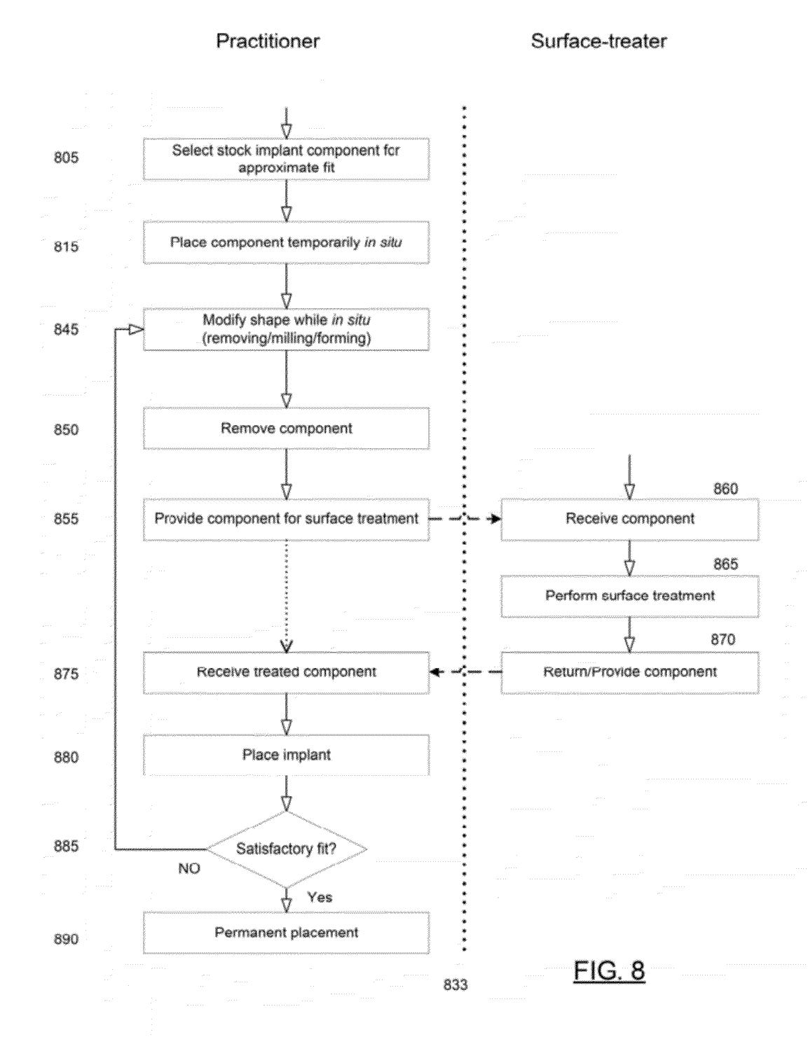

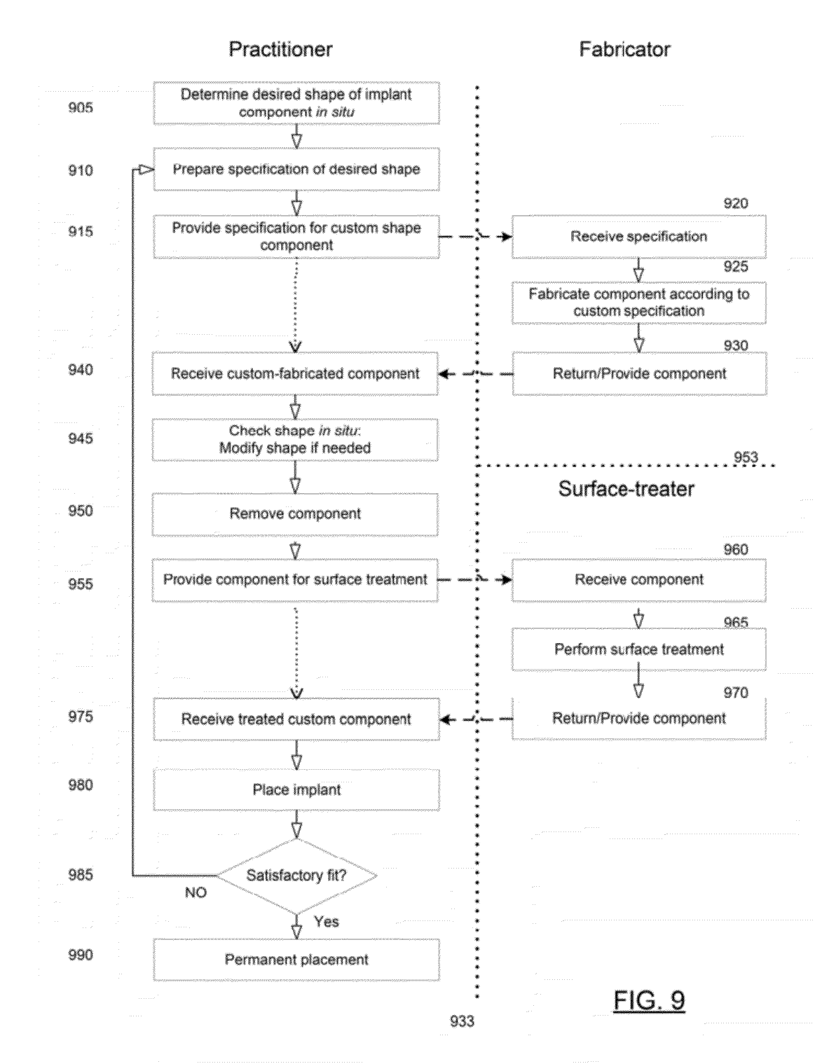

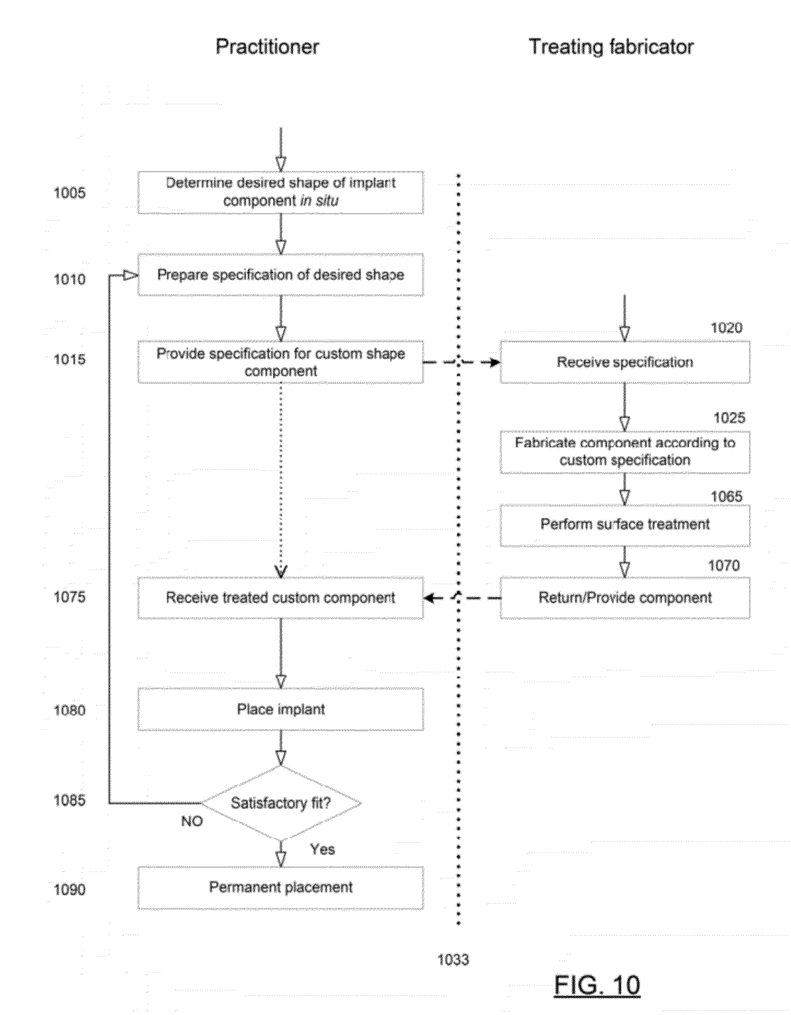

FIG. 8, FIG. 9, and FIG. 10 illustrate method embodiments according to the invention. Dental references and other references throughout are exemplary, as the techniques are not limited to dental applications.

### Embodiment of FIG. 8

FIG. 8 illustrates steps performed by two entities: a dental or medical practitioner (henceforth dental practitioner or practitioner) who custom-forms an implant component, and an entity that performs the surface treatment (henceforth surface-treater). Steps performed by the practitioner are to the left of the dotted line 833, and steps performed by the surface-treater are to the right of the dotted line 833.

The embodiment of FIG. 8 starts at the step of 805, in which the dental practitioner selects a standardized implant component for approximate fit in a particular patient's mouth. The component may also be a blank component, or other kind of component.

As shown at the step 815, after step 805 the practitioner places the component in the patient's mouth in situ, or in an exemplary alternative, in a model of the patient's mouth, and next at the step 845 modifies the component to custom-forming it, such as by removing and/or adding material to achieve a desired form. After step 845, the practitioner removes the component from the patient's body (or the model), and at the step 855 provides the component to the surface-treater for a surface treatment to be performed, as indicated by the dashed line from 855 to 860. The dotted line from 855 to 875 indicates that the practitioner waits to receive the custom-formed component at the step 875 from the surface-treater after the surface treatment has been performed.

Steps performed by the surface-treater of FIG. 8 start with the step of 860, in which the surface-treater receives the custom-formed component provided by the practitioner, next performs the desired surface treatment as shown at the step 865, and then returns or provides the custom-formed component (now with treated surface) to the practitioner at the step 870, as indicated by the dashed line from 870 to 875. The surface-treater has then completed that entity's steps for performing the surface treatment.

At the step 875, the practitioner receives the custom-formed implant component whose surface has been treated, and next at the step 880 moves the component to the particular patient's mouth and places it in situ. The practitioner then at the step 885 determines whether the component's fit and preparation are satisfactory. If so, the practitioner continues to 890 by making the placement of the implant component permanent, and completes. If not, the practitioner continues to 845 to modify the component to be more satisfactory and continues as before, or alternatively may perform another action such as discarding the component, or returning the component to the surface-treater.

### Embodiment of FIG. 9

FIG. 9 illustrates steps performed by three entities: a dental or medical practitioner (henceforth dental practitioner or practitioner) who custom-forms an implant component by providing a specification, and entity that fabricates the custom-formed implant component according to the specification, and an entity that performs the surface treatment (henceforth surface-treater). Steps performed by the practitioner are to the left of the dotted line 933. Steps performed by the fabricator are to the right of the dotted line 933 and above dotted line 953. Steps performed by the surface-treater are to the right of the dotted line 933 and below dotted line 953.

The embodiment of FIG. 9 starts at the step of 905, in which a dental practitioner determines the desired form of the custom-formed component for the particular patient. This may be by constructing a physical model, scanning the site for the implant and designing a form using CAD/CAM software such as that of DWOS as described previously, or other means.

After the step 905 the practitioner prepares a specification of the desired form for the custom-formed component using exemplary techniques as described previously or other techniques, and next as shown at the step 915 provides the specification to the fabricator, which may be for example a dental milling service, for the custom-formed component to be fabricated, as indicated by the dashed line from step 915 to step 920. The dotted line from 910 to 940 indicates that the practitioner waits to receive the custom-formed component at the step 940 from the fabricator after the component has been fabricated.

Steps performed by the fabricator of FIG. 9 start at the step of 920, in which the fabricator receives the specification prepared by the practitioner, next fabricates the custom-formed component according to the specification of step 915 as shown at the step 925. At the step 930 after the step 925 the fabricator returns or provides the custom-formed component to the practitioner, who receives it at the practitioner step 940, as indicated by the dashed line from 930 to 940. The fabricator has then completed the steps of FIG. 9 for fabricating the custom-formed component.

At step 940, the practitioner receives the custom-formed component, from the fabricator, and next at step 945 moves the component to the particular patient's mouth and places it in situ. The practitioner then at the step 945 checks whether the component's fit and preparation are satisfactory, and may modify the form of the custom-formed implant component further, such as by removing and/or adding material. Alternatively the practitioner may remove and discard the component, perform actions such as returning the component to the fabricator with additional instructions, or modifying the specification or preparing a new specification of the desired form and continuing as at step 910.

Once the practitioner has determined that the custom-formed component is satisfactory at step 945, the practitioner removes the component from the particular patient's body at step 950, and at the subsequent step 955 provides the component to the surface-treater for a surface treatment to be performed, as indicated by the dashed line from step 955 to step 960. The dotted line from step 955 to step 975 indicates that the practitioner waits to receive the custom-formed component at step 975 from the surface treater after the surface treatment has been performed.

Steps performed by the surface-treater of FIG. 9 start at the step of 960, in which the surface-treater receives the custom-formed component provided by the practitioner at practitioner step 955, next performs the desired surface treatment as shown at step 965, and then returns or provides the custom-formed component (now with treated surface) to the practitioner at step 970, as indicated by the dashed line from step 970 to step 975. The surface treatment party has then completed that entity's steps for performing the surface treatment.

At step 975, the practitioner receives the custom-formed component whose surface has been treated from the surface-treater, and next at step 980 moves the component to the particular patient's mouth and places it in situ. The practitioner then at step 985 determines whether the component's fit and preparation are satisfactory. If so, the practitioner continues to 990 by making the placement of the implant component permanent, and completes. If not, the practitioner continues again to step 910 to prepare a new or modify the previous specification, and continues as before. Alternatively the practitioner may discard the component and continue to step 905 to determinate a new shape, or perform other actions such as returning the component to the surface-treater with additional instructions.

### Embodiment of FIG. 10

In some embodiments, an implant may be provided by the practitioner providing a specification of the custom-formed implant in sufficient detail for a third party or number of third parties to fabricate the custom-formed component and perform a surface treatment on the component after fabrication. This is shown in exemplary form in FIG. 10.

FIG. 10 illustrates steps performed by two entities: a dental or medical practitioner (henceforth dental practitioner or practitioner) who custom-forms an implant component by providing a specification, and entity that fabricates the custom-formed implant component according to the specification and performs a surface treatment on all or part of the component (henceforth fabricating treater). Steps performed by the practitioner are to the left of the dotted line 1033. Steps performed by the fabricating treater are to the right of the dotted line 1033.

The embodiment of FIG. 10 starts at the step of 1005, in which a dental practitioner determines the desired form of the custom-formed component for the particular patient. This may be by constructing a physical model, scanning the site for the implant and designing a form using CAD/CAM software such as that of DWOS as described previously, or other means.

As shown at the step 1010, after the step 1005 the practitioner prepares a specification of the desired form for the custom-formed component using exemplary techniques as described previously or other techniques, and next as shown at the step 1015 provides the specification to the treating fabricator—for example, to a dental technical service—for the custom-formed component to be fabricated and surface-treated, as indicated by the dashed line from 1015 to 1020. The dotted line from 1010 to 1075 indicates that the practitioner waits to receive custom-formed component with surface-treated surface at the step 1075 from the treating fabricator after component has been fabricated and the surface treatment performed.

Steps performed by the treating fabricator of FIG. 10 start at the step 1020, in which the treating fabricator receives the implant component in the form of the specification prepared by the practitioner, and next fabricates the custom-formed component according to the specification of 1015 as shown at the step 1025. Following 1025, at the step 1065 the treating fabricator performs a surface treatment on at least a portion of a surface of the custom-formed implant component. At the step 1070 after the step 1065 the treating fabricator returns or provides the custom-formed component to the practitioner at the step 1075 as indicated by the dashed line from 1070 to 1075. The treating fabricator has then completed the steps of FIG. 10 for fabricating the custom-formed component and performing the surface treatment.

At the step 1075, the practitioner receives from the treating fabricator the custom-formed component whose surface has been treated, and next at the step 1080 moves the component to the particular patient's mouth and places it in situ. The practitioner then at the step 1085 determines whether the component's fit and preparation are satisfactory. If so, the practitioner continues to 1090 by making the placement of the implant component permanent, and completes. If not, the practitioner may discard the component, perform readily-understood actions such as returning the component to the treating fabricator with additional instructions, or in other embodiments, continuing again to step 1010 to prepare a new or modify the previous specification, and continue as before.

Further variations are readily apparent from the forgoing. For example, perhaps subject to appropriate regulatory approval, a practitioner may function as his or her own surface-treater and perform the surface treatment himself, such as an anodizing treatment. Another example is that a practitioner may determine satisfactory fit or preparation of an implant component while it outside the patient's body, or an entity may perform steps in a different order from those in the example embodiments. As a further example, a custom-formed implant may be formed or specified by one practitioner, and the custom-formed implant with surface-treated surface moved to the patient's mouth and implanted by a second practitioner, who may or may not operate independently of the first practitioner. The dental practitioner may be a group practice made up of a number of individuals, actions described herein as performed by a practitioner may be performed in whole or in part by a technician or other party at the practitioner's behest, and the third parties fabricating and/or surface-treating a custom-formed implant component may be a single party or associations such as companies and may perform steps in combination or may also sub-divide steps.

Upon consideration, numerous other advantages to and embodiments of the techniques will be readily apparent, and the techniques are not limited to the various forms of the embodiments described, nor are they limited to the techniques illustrated in the figures. Further variations are readily apparent.

### CONCLUSION

For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

What is claimed is:

1) A method of making a custom medical implant, comprising the steps of:
receiving at least a portion of a medical implant that has been custom-formed for a particular patient by a first medical practitioner;
performing a surface treatment on at least one portion of a surface of the implant portion; and
providing the implant portion to a second medical practitioner for implantation in the particular patient subsequent to performing the surface treatment.

2) The method set forth in claim 1, wherein the first medical practitioner and the second medical practitioner are the same medical practitioner.

3) The method set forth in claim 1, wherein the implant portion is a portion of a dental prosthesis.

4) The method set forth in claim 1, wherein the implant portion has been custom-formed at least in part by removal of material from a surface of the implant.

5) The method set forth in claim 1, wherein the portion of the medical implant has been custom-formed according to a provided specification.

6) The method set forth in claim 1, wherein at least a portion of the implant portion is comprised of a metal material suitable for use in a human body and the step of performing the surface treatment further comprises anodizing at least a portion of a surface of the implant portion.

7) The method set forth in claim 1, wherein the step of performing the surface treatment further comprises bonding a material to at least a portion of a surface of the implant portion.

8) A method of providing a custom medical implant, comprising the steps of:
custom-forming at least a portion of a medical implant for a particular patient;
providing the custom-formed portion of the implant for the express purpose of a surface treatment being performed on at least one surface portion of the implant; and
receiving the implant portion subsequent to treatment.

9) The method set forth in claim 8, further comprising the step of:
subsequent to the step of receiving the implant portion, affixing the implant portion to the body of the particular patient.

10) The method set forth in claim 8, wherein the portion of the medical implant is a portion of a dental prosthesis.

11) The method set forth in claim 8, wherein
the step of custom forming further comprises creating a specification for at least a portion of the form of the medical implant; and
the step of providing is performed at least in part by providing the specification.

12) The method set forth in claim 8, wherein the step of custom forming further comprises removing material from the portion of the implant.

13) A custom-formed medical implant produced by the process of:
custom-forming at least a portion of a medical implant for a particular patient; and
performing a surface treatment on at least a portion of a surface of the implant subsequent to the implant having been custom-formed.

14) The medical implant set forth in claim 13, wherein the medical implant is a dental implant.

15) The medical implant set forth in claim 13, wherein the step of performing the surface treatment further comprises anodizing at least a portion of a surface of the implant.

16) The medical implant set forth in claim 13, wherein the step of custom forming the portion of the medical implant further comprises fabricating the portion of the medical implant according to a specification.

17) A medical implant component, comprising:
first portion having a form which is compatible with a corresponding first portion of a second medical implant component that has a standardized form; and
a second portion having a form which is not identical with a corresponding second portion of the second medical implant
wherein the second portion of the first medical implant component is expressly intended to be custom-formed for use in a particular patient's body.

18) The medical implant component set forth in claim 17, wherein the medical implant component is a dental implant component.

19) The medical implant component set forth in claim 17, wherein the second portion of the medical implant component is expressly intended to be custom-formed at least in part by the removal of material of the second portion.

20) The medical implant component set forth in claim 19, wherein the medical implant component is a dental abutment implant component.

21) The dental abutment implant component set forth in claim 19, wherein the second portion of the dental implant component has a portion that is cylindrical in form.

22) A method of providing a custom dental implant abutment, comprising the steps of:
custom-forming at least a portion of a surface of a dental abutment for a particular patient by removal of material from the at least one surface portion of the abutment, the dental abutment being comprised at least in part of a titanium material;
providing the abutment for the express purpose of a surface treatment being performed on the at least one surface portion of the abutment, the surface treatment comprising anodization of at least a portion of the surface portion to produce a pink color;
receiving the abutment for which the surface treatment has been performed; and
affixing the abutment to the patient's mouth by attachment with an endosseous dental implant component implanted in the patient's mouth.
